(19) United States
(12) Patent Application Publication
(10) Pub. No.: US 2020/0191250 A1
(43) Pub. Date: Jun. 18, 2020

(54) GEAR

(71) Applicant: LENTUS COMPOSITES LIMITED, Banbury Oxfordshire (GB)

(72) Inventors: MICHAEL DEWHIRST, Eynsham Oxfordshire (GB); PAUL LEWIS, Eynsham Oxfordshire (GB)

(21) Appl. No.: 16/500,161

(22) PCT Filed: Mar. 28, 2018
(86) PCT No.: PCT/GB2018/050852

§ 371 Date: Oct. 2, 2019

(30) Foreign Application Priority Data
Apr. 6, 2017 (GB) 1705587.2

(51) Int. Cl. F16H 55/17; F16H 55/06; F16H 55/12

(52) U.S. Cl. CPC F16H 55/17; F16H 55/12; F16H 55/06

(57) ABSTRACT

A gear comprising an annular gear component 12, a drive transfer section 24, the drive transfer section 24 being of composite material form, the drive transfer section 24 including a flange region 28 for engagement with the gear component 12, and a hoop element 32 applying a load to the flange region 28 to compress the flange region 28 against the gear component 12 and provide support for the gear component 12.

This invention relates to a gear, and in particular to a gear at least part of which is of composite material form.

Composite materials are used in a number of applications in which it is desired to provide components of good strength whilst being of low weight. By way of example, they are used in a number of aerospace related applications as the weight reductions that can be made through the use of composite materials, whilst maintaining component strength, allow the overall weight of an aircraft to be reduced, and hence allow fuel efficiency enhancements to be made, in use. It will be appreciated, however, that this represents just one example environment in which composite materials may be used, and the invention is not restricted in this regard.

One application in which benefits may be made through reducing weight is in the production of rotary components such as gears. In applications of this type, the weight savings achieved through use of composite materials may have the additional benefit that the inertia associated with individual gears of an overall gear train may be reduced, which may be advantageous in some applications. The differences in strength and stiffness between composite materials and many materials traditionally used in gears means that simply substituting composite materials for the traditionally used materials is inappropriate.

It is an object of the invention, therefore, to provide a gear, at least part of which is of composite material.

According to the present invention there is provided a gear comprising an annular gear component, a drive transfer section, the drive transfer section being of composite material form, the drive transfer section including a flange region for engagement with the gear component. A hoop element is preferably provided applying a load to the flange region to compress the flange region against the gear component and provide support for the gear component.

Such an arrangement is advantageous in that the drive transfer section is of composite material form and so may be of relatively low weight compared to arrangements in which this part of the gear is of a traditional material. The weight savings are made without negatively impacting upon the strength and stiffness of the gear component through the provision of the hoop member which provides additional support to the gear component.

The gear component may be of, for example, metallic form, including a face with which the flange section is cooperable, and a toothed face. The face with which the flange section is cooperable may be of micro-splined form, or be provided with another texture to enhance cooperation between the flange section and the gear component to enhance drive transmission therebetween. Whilst metallic materials will be used in a number of applications, depending upon the application in which the gear is used, other materials may be used. By way of example, the gear component may be of polymeric form, or may be of a composite material.

The hoop element is conveniently of a composite material. However, this need not always be the case and other materials may be used. By way of example, the hoop element could be of metallic form. Where of a composite material, it is conveniently of filament wound form.

The drive transfer section is preferably of multi-layered form, comprising layers of a reinforcing fibre material impregnated with a suitable binder material, for example of a resin material form. The drive transfer component preferably takes the form of a disc, or flat element of another shape, the flange section upstanding from a plane of the disc or flat element. The flange section is preferably defined by at least some of the layers of reinforcing fibre material. The parts of the layers located within the flange section are preferably non-perpendicularly angled to the plane of the disc of flat element. Such an arrangement is advantageous in that driving contact may be established between the gear component and a number of the layers of reinforcing material with the result that loads are more uniformly distributed within the drive transfer component than may otherwise be the case.

A second gear component may also be provided. By way of example, the second gear component may be located to the inner periphery of the drive transfer section with the first mentioned gear component located to the outer periphery thereof. The cooperation between the second gear component and the drive transfer section is conveniently substantially as described hereinbefore. The second gear component may comprise a toothed ring gear element. Alternatively, it may comprise a splined hub for attachment to a shaft. It will be appreciated that in an arrangement of this type the drive transfer section transmits drive between the gear components.

If desired, two drive transfer sections may be provided, arranged parallel to one another. In such an arrangement a void may be defined between the drive transfer sections and the gear components.

The teeth of the first mentioned gear component may be outwardly presented, or may be inwardly presented, depending upon the application in which the invention is to be employed.

The invention will further be described, by way of example, with reference to the accompanying drawings, in which:

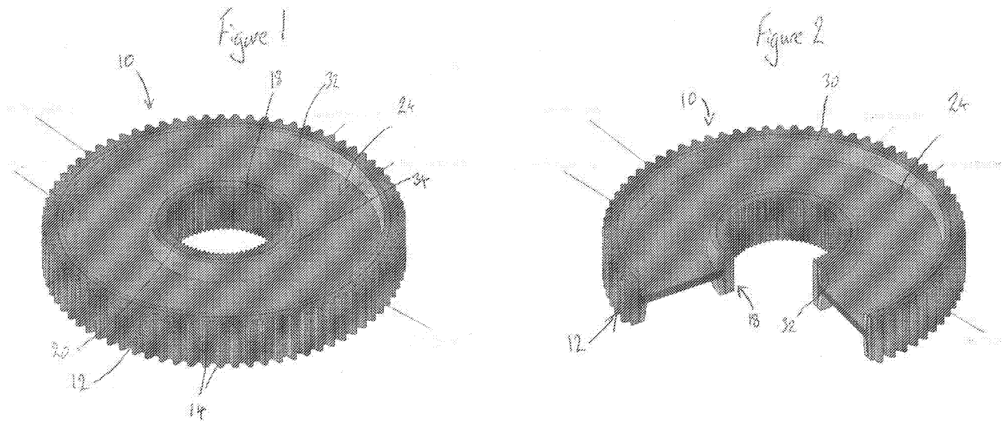

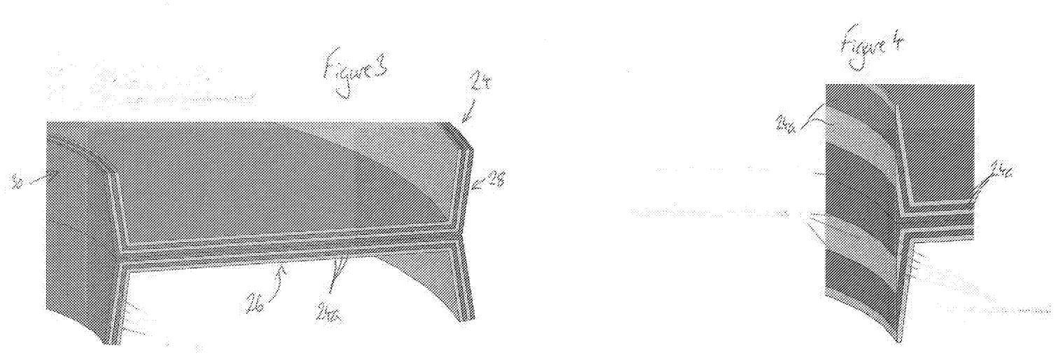

FIG. 1 is a view illustrating a gear in accordance with an embodiment of the invention;

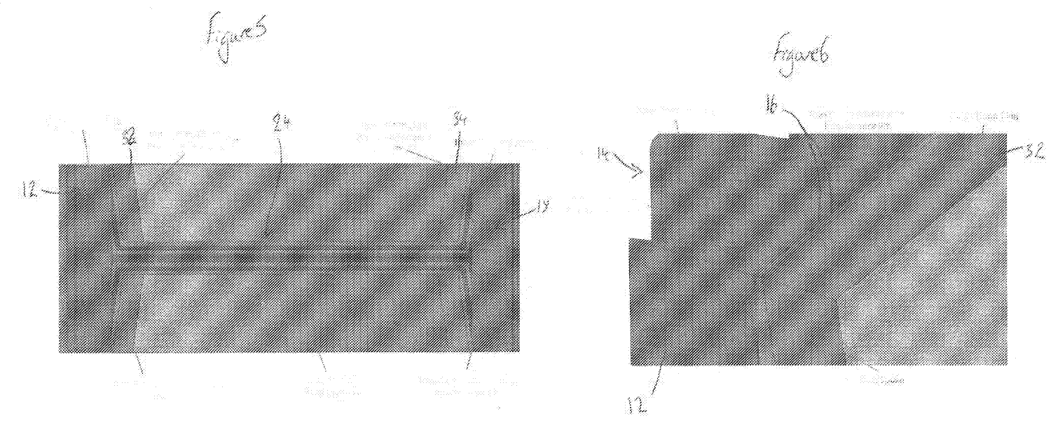

FIG. 2 is a view similar to FIG. 1 but with part broken away;

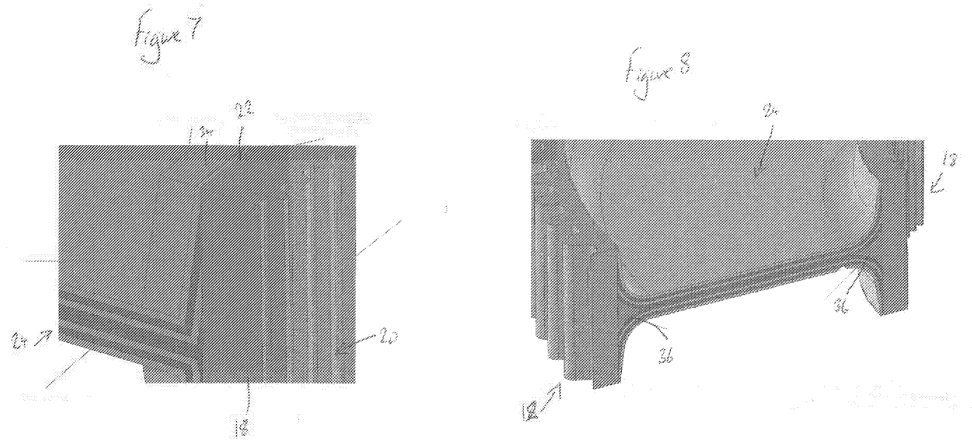

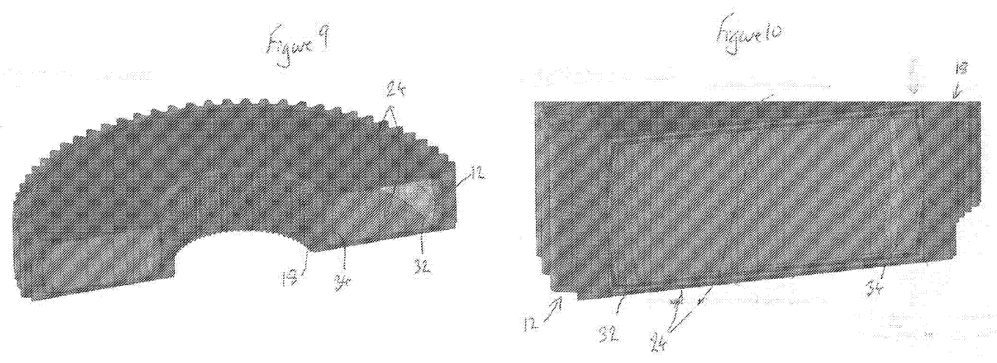

FIGS. 3 and 4 are diagrammatic views illustrating part of the gear of FIGS. 1 and 2;

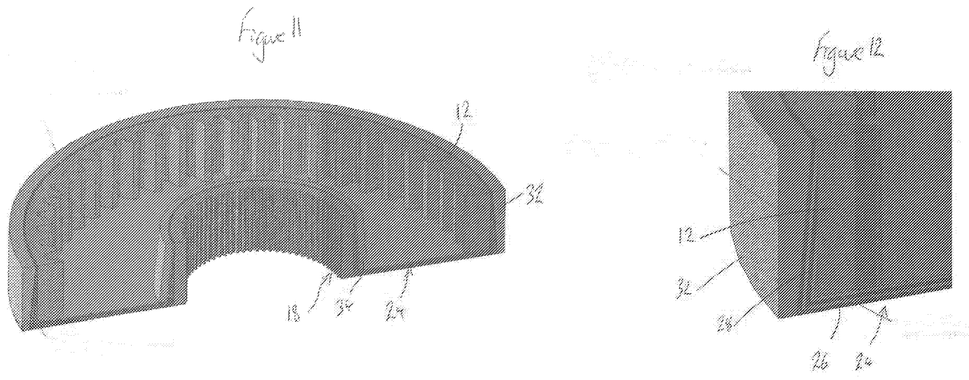

FIG. 5 is a sectional view illustrating part of the gear;

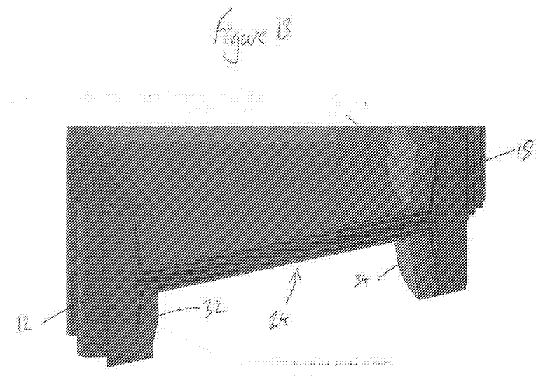

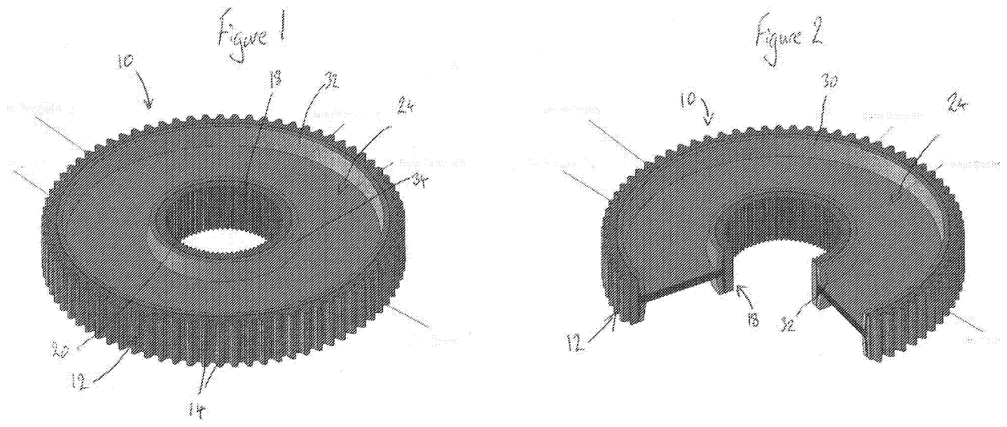

FIGS. 6 and 7 are views illustrating the cooperation between the flange section and the gear components;

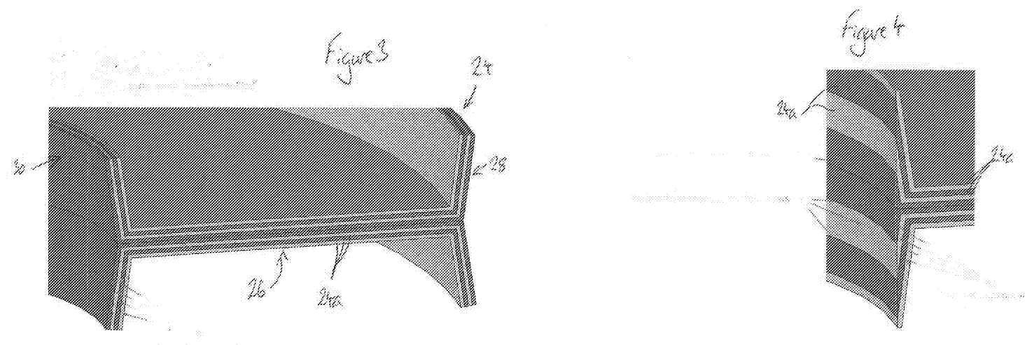

FIG. 8 is a view illustrating a modification;

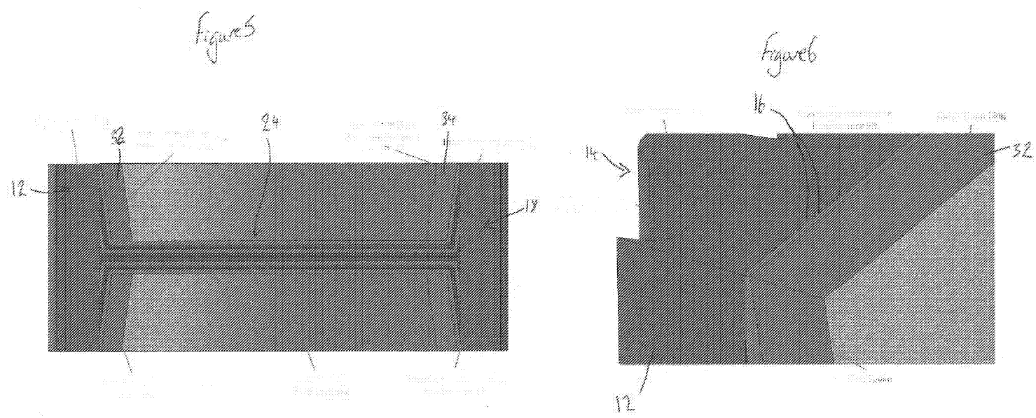

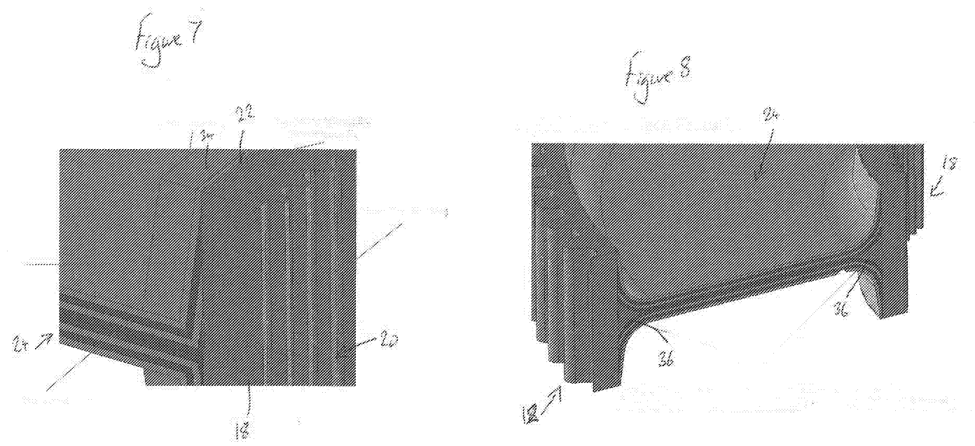

FIGS. 9 and 10 illustrate a gear in accordance with another embodiment of the invention;

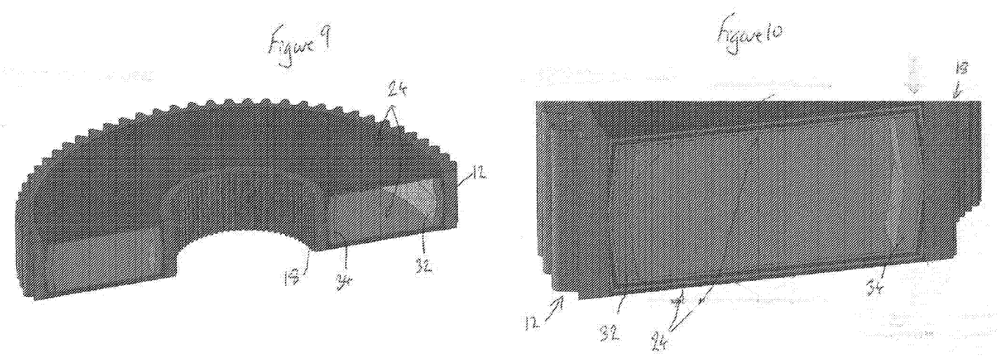

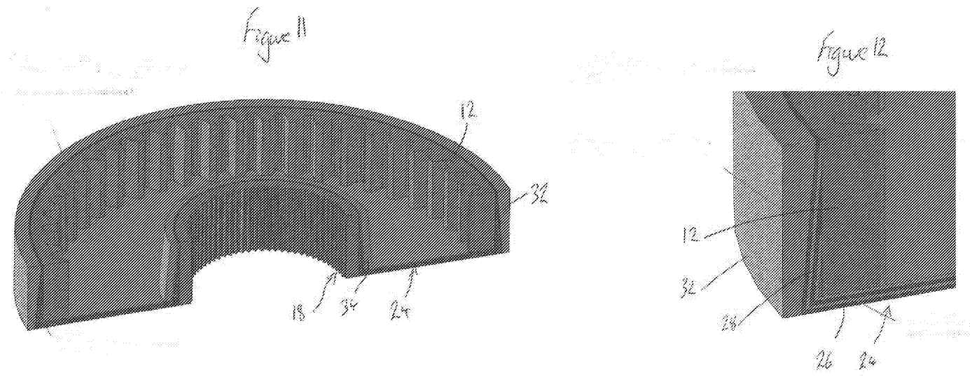

FIGS. 11 and 12 illustrate another embodiment; and

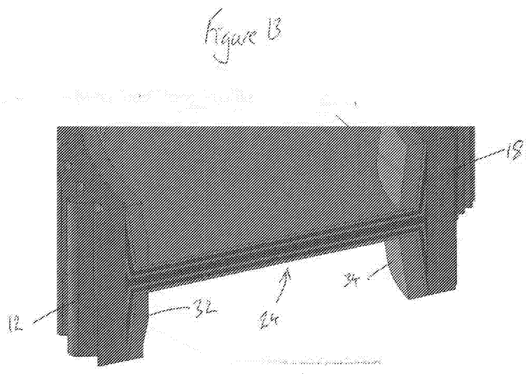

FIG. 13 illustrates a further embodiment of the invention.

Referring firstly to FIGS. 1 to 7 of the accompanying drawings, a gear 10 is illustrated. The gear 10 comprises an outer gear component 12 of generally annular form including, on its outer peripheral surface, a series of gear teeth 14. On its inner peripheral surface, the outer gear component 12 is provided with a series of shallow grooves or micro-spline formations 16.

The gear 10 further comprises an inner gear component 18 which, like the outer gear component 12, is of annular form. It includes, on its inner peripheral surface, a series of gear teeth 20. Its outer peripheral surface is provided with grooves or micro-splines 22.

In the arrangement shown the gear components 12, 18 are of metallic form with the teeth machined thereon. However, it will be appreciated that this need not always be the case and that arrangements are possible in which other materials are used. By way of example, in some applications the gear components 12, 18 may be of moulded polymeric material form or may be of a suitable composite material, for example machined to include the required gear teeth formations. It will be appreciated that the selection of material will depend, to some extent, upon the requirements of the application in which the gear is to be used. By way of example, in some applications it may be required to use metallic materials in order to withstand wear and have the required strength. However, in other, lower load and wear applications the use of weaker polymeric materials may be acceptable.

The outer and inner gear components 12, 18 are interconnected by a drive transfer section 24. The drive transfer section 24 is of composite material form, for example taking the form of a series of layers 24a of a reinforcing fibre material bound to one another by a resin. One convenient technique by which the drive transfer section may be fabricated may be to use fabric materials woven, knitted or otherwise produced using suitable material fibres to form each layer 24a, the layers 24a being built up within a suitably shaped mould, the layers 24a being impregnated with a suitable resin material which is cured or allowed to cure to form the finished component. The materials may be pre impregnated with the resin material, if desired, but this need not be the case and arrangements in which resin is applied separately are also possible. Alternatively, squash moulding techniques of bulk materials may be used, if desired.

As illustrated, the drive transfer section 24 is shaped to define an annular disc 26, the inner and outer peripheries of which are formed with integral flange regions or flanges 28, 30. Each flange 28, 30 includes parts of one or more of the layers 24a. As best shown in FIGS. 3 and 4, the parts of the layers 24a located within the flanges 28, 30 are not perpendicular to the plane of the disc 26, but rather are angled thereto at an angle greater than 90′, for example falling within the range of 92-100′. After curing of the drive transfer section material, the surfaces of the flanges 28, 30 which cooperate, in use, with the gear components 12, 18 are machined to be perpendicular to the plane of the disc 26. Such machining results in parts of a plurality of the layers 24a, and the reinforcing fibres thereof, being exposed at the surfaces which, in use, cooperate with the gear components 12, 18.

In the arrangement shown, the flanges 28, 30 extend to both sides or surfaces of the disc 26.

Inner and outer hoop members 32, 34 are provided adjacent the flanges 28, 30, the hoop members 32, 34 being arranged to apply loads to the flanges 28, 30 to compress the flanges 28, 30 against the inner and outer gear components 12, 18 to result in a good interference fit between the machined surfaces of the flanges 28, 30 and the micro-splined or otherwise textured surfaces of the gear components 12, 18. Furthermore, the hoop members 32, 34 serve to increase the hoop stiffness and strength of the inner and outer gear components 12, 18 which, in a more traditional gear design, may have been provided by the interconnections between the inner and outer parts of the gear. The inner and outer hoop members 32, 34 are conveniently of a suitable composite material form. By way of example, they may take the form of filament wound composite elements with a high hoop fibre content. Alternatively, they could comprise squash moulded composite components. However, it will be appreciated that other materials may be used, and the choice of material used for these components may depend upon the application in which the gear is to be used. By way of example, metallic materials may be used.

As illustrated, as the flanges 28, 30 extend to both sides or surfaces of the disc 26, two inner hoop members 32 and two outer hoop members 34 are provided in this embodiment.

In use, it will be appreciated that the outer and inner gear components 12, 18 are interconnected by the drive transfer section 24 in such a manner that torque applied to one of the gear components 12, 18 is transmitted to the other of the gear components 12, 18 by way of the drive transfer section 24. The nature of the cooperation between the gear components 12, 18 and the drive transfer section 24 arising through the exposure of parts of a number of the layers 24a at the surfaces of the flanges 28, 30 which cooperate with the gear components 12, 18 results in a more uniform spread of the transmitted loads within the structure of the drive transfer section 24, the cooperation of the exposed layers 24a with the micro-spline or other formations 16, 22, and the interference fit of the drive transfer section 24 with the gear components 12, 18, resulting in effective drive coupling between the gear components 12, 18 and the drive transfer section 24.

The hoop members 32, 34 may be retained in position using any suitable technique. It is envisaged that they will simply be pushed into position, and that frictional forces between the hoop members 32, 34 and the sloping surfaces of the flanges 28, 30 will be sufficient to retain the hoop members 32, 34 in position. However, suitable adhesives could be applied, if desired, to aid retention of the hoop members 32, 34. By appropriate selection of the angles of the sloped surfaces of the flanges 28, 30, it will be appreciated that the use of such adhesives may be avoided in many applications.

Where it is thought that positive retention of the hoop members 32, 34 is required, this could potentially be achieved through the formation of retaining pips or the like on the flanges 28, 30 for cooperation with parts of the hoop members 32, 34.

Although in the arrangement shown the gear components 12, 18 are both of metallic form, and the connections between the gear components 12, 18 and the drive transfer section 24 are substantially the same, this need not be the case. Where the inner and outer gear components 12, 18 are expected to bear significantly different loadings to one another then different materials may be employed in these parts of the gear, and the connections between the gear components 12, 18 and the drive transfer section 24 may differ from one another.

Turning next to FIG. 8, a slightly modified form of drive transfer section 24 is illustrated in which, during moulding or formation thereof an annular insert 36 is incorporated to increase the radius of curvature through which the fibres are bent between the disc 26 and the flanges 28, 30. As a consequence, load transfer is enhanced and the formation of stress concentrations is reduced. The insert 36 is conveniently of premoulded composite material form, for example of bulk moulded form. Whilst not shown, hoop members 32, 34 are employed to complete the assembly of the gear in substantially the same fashion as described hereinbefore. The modification shown in FIG. 8 may be applied to any of the arrangements described herein.

FIGS. 9 and 10 illustrate a gear in which a pair of drive transfer sections 24 are arranged parallel to one another, the drive transfer sections 24 and gear components 12, 18 together defining an annular void. It is thought that an arrangement of this type may be beneficial in that stiffness may be enhanced. Assembly may involve assembling the pair of drive transfer sections 24 and the pair of hoop members 32, 34, subsequently machining the exposed surfaces of the flanges 28, 30 and then inserting the assembly between the inner and outer gear components 12, 18. In this arrangement, a single inner hoop member 34 and a single outer hoop member 32 are provided.

FIGS. 11 and 12 illustrate a gear in which the outer gear component 12 is provided with teeth on its inwardly facing surface rather than on its outer surface. In this arrangement, the flange 28 and outer hoop member 32 are located radially outward of the outer gear component 12.

In any of the arrangements described hereinbefore, the hoop members 32, 34 may be modified to take the profile of the outer hoop member 32 illustrated in FIG. 13, such an arrangement being advantageous in that different parts of the hoop members 32, 34 may be of different stiffnesses which can avoid or reduce the undesirable generation of stresses within the gear components that could otherwise result in deformation of parts thereof.

Whilst in the arrangements described hereinbefore the drive section 24 is of generally circular form, other arrangements are possible without departing from the scope of the invention. By way of example, it could be of polygonal shape, for example being used with gear components parts of which are similarly shaped.

All of the arrangements described hereinbefore are advantageous in that they make use of composite materials in the gear structure, allowing weight savings to be made which is desirable in a number of applications.

Whilst the drive transfer sections 24 illustrated herein are shown as being of solid form, arrangements may be possible in which openings are formed therein, for example with the result that the drive transfer section is of spoked or spoke-like form.

Although the arrangements described hereinbefore make use of hoop member to compress the flanges of the associated drive transfer sections against the gear components, in some arrangement adequate drive transmission may be possible without such hoop members being provided. Accordingly, they may be omitted in some circumstances.

A wide range of modifications and alterations of the arrangements described hereinbefore are possible without departing from the scope of the invention as defined by the appended claims.

1. A gear comprising an annular gear component and a drive transfer section, the drive transfer section being of composite material form and including a flange region for engagement with the gear component.

2. A gear according to claim 1, further comprising a hoop element applying a load to the flange region to compress the flange region against the gear component and provide support for the gear component.

3. A gear according to claim 1, wherein the gear component is of metallic form, including a face with which the flange section is cooperable, and a toothed face.

4. A gear according to claim 3, wherein the face with which the flange section is cooperable is of micro-splined form.

5. A gear according to claim 1, wherein the gear component is of polymeric form, or is of a composite material.

6. A gear according to claim 2, wherein the hoop element is of a composite material.

7. A gear according to claim 6, wherein the hoop element is of filament wound form.

8. A gear according to claim 2, wherein the hoop element is of metallic form.

9. A gear according to claim 1, wherein the drive transfer section is of multi-layered form, comprising layers of a reinforcing fibre material impregnated with a suitable binder material.

10. A gear according to claim 9, wherein the drive transfer component takes the form of a flat element, the flange section upstanding from a plane of the flat element.

11. A gear according to claim 10, wherein the flange section is defined by at least some of the layers of reinforcing fibre material.

12. A gear according to claim 11, wherein the parts of the layers located within the flange section are non-perpendicularly angled to the plane of the flat element.

13. A gear according to claim 12, wherein parts of the layers are exposed.

14. A gear according to claim 10, wherein the flat element is of disc shaped form.

15. A gear according to claim 1, wherein a second gear component is provided, the second gear component being located to the inner periphery of the drive transfer section with the first mentioned gear component located to the outer periphery thereof.

16. A gear according to claim 15, wherein the drive transfer section includes a second flange region for engagement with the second gear component, and a second hoop element applies a load to the second flange region to compress the second flange region against the second gear component and provide support for the second gear component.

17. A gear according to claim 1, wherein two drive transfer sections are provided, arranged parallel to one another.

18. A gear according to claim 1, wherein the gear component includes teeth which are outwardly presented.

19. A gear according to claim 1, wherein the gear component includes teeth which are inwardly presented.
